(19) United States
(12) Patent Application Publication
(10) Pub. No.: US 2005/0204582 A1
(43) Pub. Date: Sep. 22, 2005

(54) Exhaust fan assembly

(76) Inventors: Anthony J. Rossi, Indianapolis, IN (US); Michael G. Seliger, Marathon, WI (US); Scott Thomsen, Wausau, WI (US); Gary Zess, Vernon, CT (US)

Correspondence Address: QUARLES & BRADY LLP, 411 E. WISCONSIN AVENUE, SUITE 2040, MILWAUKEE, WI, 53202-4497, US

(21) Appl. No.: 11/039,684

(22) Filed: Jan. 20, 2005

Related U.S. Application Data
(63) Continuation-in-part of application No. 10/984,052, filed on Nov. 9, 2004.
(60) Provisional application No. 60/588,074, filed on Jul. 15, 2004.
(60) Provisional application No. 60/537,609, filed on Jan. 20, 2004.
(60) Provisional application No. 60/625,220, filed on Nov. 5, 2004.

(51) Int. Cl. F26B 19/00

(52) U.S. Cl. 34/551

(57) ABSTRACT

An exhaust fan assembly is provided for expelling contaminated air from a building. The assembly includes fan housing connected to the building via a duct. The fan housing contains a fan the draws air from the building through the duct. An extension is mounted to the outlet end of the fan housing, and has a cylindrical upper end connected to a nozzle. A windband is connected to the upper end of the nozzle, and provides an air entrainment path that allows ambient air to mix with the exhaust air prior to exiting through an exhaust fan assembly outlet.

### CROSS-REFERENCE TO RELATED APPLICATIONS

This application claims priority to U.S. Provisional Patent Application Ser. No. 60/588,074 filed on Jul. 15, 2004, U.S. Provisional Patent Application Ser. No. 60/537,609 filed on Jan. 20, 2004, and U.S. Provisional Patent Application Ser. No. 60/625,220 filed Nov. 5, 2004, and is a continuation-in-part of U.S. Utility patent application Ser. No. 10/984,052 filed on Nov. 9, 2004 and entitled “Exhaust Fan Assembly”, the disclosure of each of which is hereby incorporated by reference as if set forth in its entirety herein.

### BACKGROUND OF THE INVENTION

The present invention relates generally to exhaust fans, and more particularly to exhaust fans of the type that draw contaminated air from one or more fume hoods dispersed throughout a building, mix the contaminated air with ambient air to dilute the contaminants, and vent the diluted air from the building into the ambient environment.

There are many different types of exhaust systems for buildings. In most of these the objective is to simply draw air from inside the building in an efficient manner. In building such as laboratories, fumes are produced by chemical and biological processes, which may have an unpleasant odor, are noxious or toxic. One solution to rid the building of these fumes is to exhaust them through a tall exhaust stack which releases the fumes far above ground and roof level. Such exhaust stacks, however, are expensive to build and are unsightly.

Another solution is to mix the fumes with fresh air to dilute the contaminated air, and exhaust the diluted air upward from the top of the building at a high velocity. The exhaust is thus diluted and blown high above the building. Examples of such systems are described in U.S. Pat. Nos. 4,806,076; 5,439,349 and 6,112,850.

One such system forces air from the building using a centrifugal fan. The centrifugal fan forces air into a bifurcated duct that houses a pair of adjacent conduits, each conduit defined by an outer wall and an inner wall that converge in a direction downstream with respect to air flow. A windband is attached to the exhaust end of the duct, and provides a pathway that entrains air into the building exhaust. Unfortunately, a significant pressure drop is caused across the conduits. Furthermore, the conduits converge toward each other and away from the air entrainment pathway, thereby reducing the flow rate of ambient air that is entrained into the building exhaust.

What is therefore desired is a building exhaust system including a building exhaust stack coupled to a centrifugal fan that achieves higher performance levels than those of with conventional systems.

### BRIEF SUMMARY OF THE INVENTION

The present invention is an exhaust fan assembly for receiving exhaust air from a building at an air inlet, mixing the exhaust air with ambient air, and blowing the mixed air upward to a substantial plume height above an air outlet.

In accordance with one aspect of the invention, the exhaust fan assembly includes a fan housing containing a fan that draws the exhaust air from the building and forces the air through a fan housing outlet. A nozzle is disposed downstream of the fan housing, and includes an outer enclosed wall and an inner wall that form a converging annular conduit that receives the exhaust air from the fan. A windband is disposed downstream of the nozzle, and provides an air entrainment path receiving ambient air such that the ambient air mixes with the exhaust air in the windband. The windband further includes an outlet that expels the mixed air.

In accordance with another aspect of the invention, the exhaust fan assembly includes a fan housing containing a fan that draws the exhaust air from the building and forces the air through a fan housing outlet. A nozzle is disposed downstream of the fan housing, and includes an outer enclosed wall and an inner wall that diverges toward the outer wall to form a converging conduit that receives the exhaust air from the fan. A windband is disposed downstream of the nozzle, and provides an air entrainment path receiving ambient air such that the ambient air mixes with the exhaust air in the windband. The windband further includes an outlet that expels the mixed air.

In accordance with yet another aspect of the invention, the exhaust fan assembly includes a duct connected to the ventilation network that receives the exhaust air at one end, the conduit defining an outlet end. A fan housing defining an inlet that is connected to the outlet of the duct; the fan housing containing a centrifugal fan that draws the exhaust air from the building and forces the air through a fan housing outlet. A connector has a rectangular base connected to the fan housing, and a cylindrical upper end. The connector defines a conduit that receives receiving the exhaust air from the fan housing outlet. A nozzle includes 1) an outer enclosed wall connected to the cylindrical upper end of the connector and 2) an inner wall that diverges towards the outer enclosed wall to form a converging annular conduit receiving the exhaust air from the conduit of the connector. A windband is connected to the outer enclosed wall of the nozzle. The windband has a frustum-shape with a circular opening at its lower end which is coaxial with said nozzle. The lower end of the windband is substantially coplanar with said nozzle.

In the following description, reference is made to the accompanying drawings, which form a part hereof, and in which there is shown by way of illustration, and not limitation, a preferred embodiment of the invention. Such embodiment also does not define the scope of the invention and reference must therefore be made to the claims for this purpose.

### BRIEF DESCRIPTION OF THE DRAWINGS

Reference is hereby made to the following drawings in which like reference numerals correspond to like elements throughout, and in which:

FIG. 1 is a schematic perspective view of a building ventilation system constructed in accordance with principles of the present invention;

FIG. 2 is a side elevation view of an exhaust fan assembly constructed in accordance with the preferred embodiment including an exhaust stack mounted to a fan housing;

FIG. 3 is a sectional side elevation view of the exhaust stack and a portion of the fan housing illustrated in FIG. 2 showing the air flow through the exhaust stack;

FIG. 4 is an bottom plan view of the exhaust stack illustrated in FIG. 3;

FIG. 5 is a perspective view of the exhaust stack illustrated in FIG. 4;

FIG. 6 is a schematic diagram of the fan assembly showing the parameters which determine the desired performance; and

FIG. 7 is a sectional side elevation view of an exhaust stack similar to FIG. 3 but constructed in accordance with an alternative embodiment.

### DETAILED DESCRIPTION OF THE PREFERRED EMBODIMENT

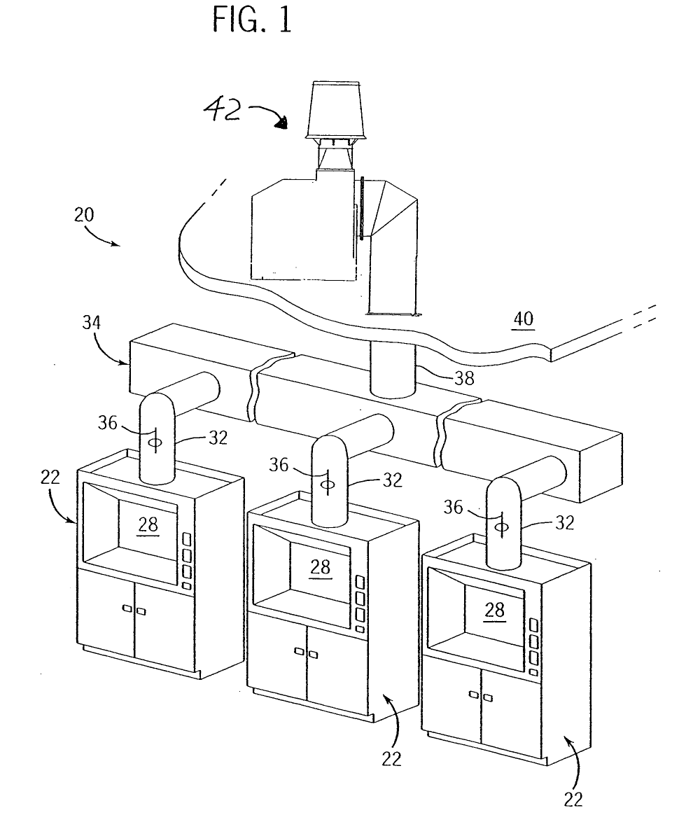

Referring initially to FIG. 1, a building ventilation system 20 includes one or more fume hoods 22 of the type commonly installed in commercial kitchens, laboratories, manufacturing facilities, or other appropriate locations throughout a building that create noxious or other gasses that are to be vented from the building. In particular, each fume hood 22 defines a chamber 28 that is open at a front of the hood for receiving surrounding air. The upper end of chamber 28 is linked to the lower end of a conduit 32 that extends upwardly from the hood 22 to a manifold 34. Manifold 34 is further connected to a riser 38 that extends upward to a roof 40 or other upper surface of the building. The upper end of riser 38 is, in turn, connected to an exhaust fan assembly 42 that is mounted on top of roof 40 and extends upwardly away from the roof for venting gasses from the building. The components of exhaust fan assembly 42 are made of a metal, and preferably steel, unless described otherwise herein.

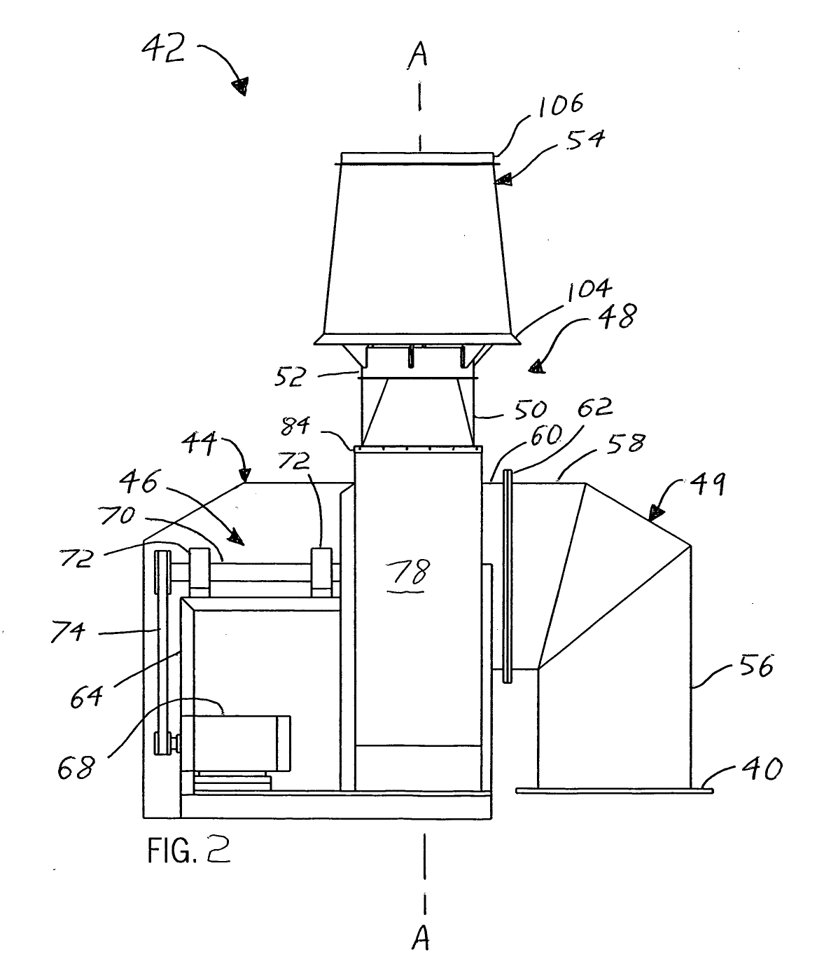

The exhaust fan assembly 42 is illustrated in FIG. 2, and includes a fan housing 44 at its base that contains a centrifugal fan assembly 46. Housing 44 is, in turn, connected to an exhaust stack 48 that extends upward about vertical axis A-A. Exhaust stack 48 includes a stack extension 50 extending upward from housing 44, and a modular air entraining assembly 51 indirectly mounted onto roof 40 via stack extension 50 and fan housing 44 (though it should be appreciated that entraining assembly 51 could alternatively be mounted directly onto roof 40, as will be described in more detail below). Air entraining assembly 51 includes a nozzle 52 and a windband 54 connected to the upper end of nozzle 52. A duct 49 delivers building exhaust from riser 38 to fan housing 44. Each of these components is described in more detail below. During operation, exhaust fan assembly 42 draws an airflow that travels from each connected fume hood 22, through chamber 28, conduits 32, manifold 34, riser 38, and duct 16. This exhaust air is mixed with fresh air before being expelled upward at high velocity through an opening in the top of the windband 54.

The control of this system typically includes both mechanical and electronic control elements. A conventional damper 36 is disposed in conduit 32 at a location slightly above each hood 22, and is automatically actuated between a fully open orientation (as illustrated) and a fully closed orientation to control exhaust flow through the chamber 28. Hence, the volume of air that is vented through each hood 22 is controlled.

The building can be equipped with more than one exhaust fan assembly 42, each such assembly 42 being operably coupled either to a separate group of fume hoods 22 or to manifold 34. Accordingly, each exhaust fan assembly 42 can be responsible for venting noxious gasses from a particular zone within the building, or a plurality of exhaust fan assemblies 42 can operate in tandem off the same manifold 34. In addition, the manifold 34 may be coupled to a general room exhaust in building. An electronic control system (not shown) may be used to automatically control the operation of the system.

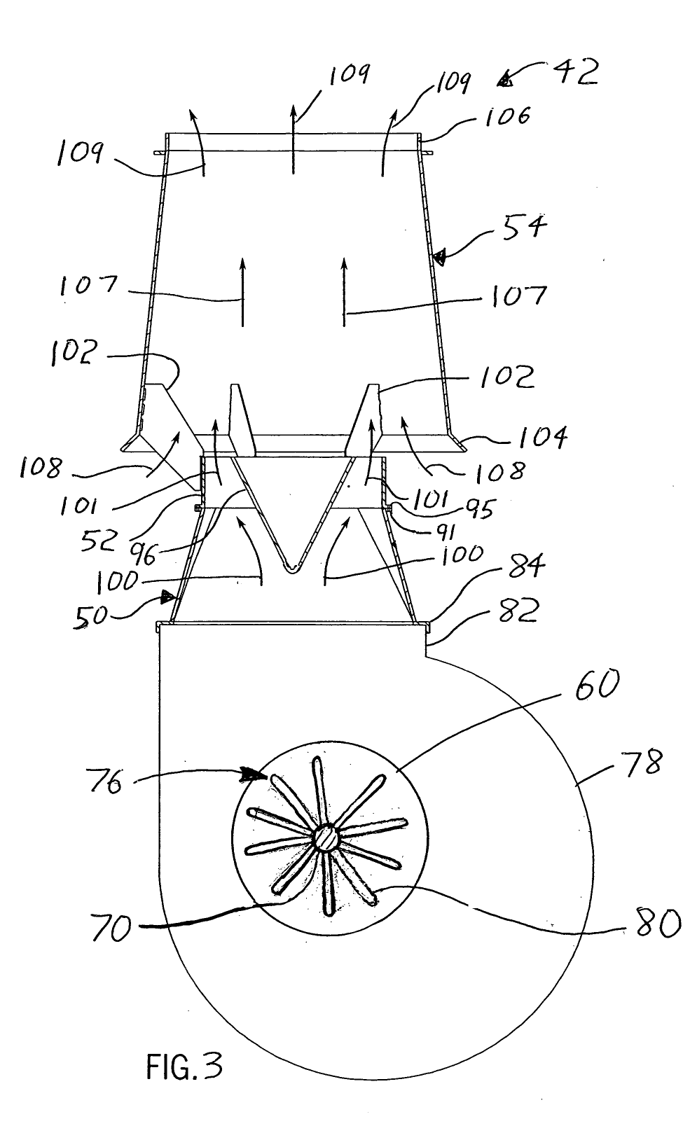

Referring now to FIGS. 2 and 3, duct 49 includes a vertical portion 56 extending up from roof 40 that receives building exhaust from riser 38, and a horizontal portion 58 that is connected to an inlet port 60 of housing 44 via a connector flange 62. Housing 44 includes a frame 64 that supports a fan motor 68. A drive belt 74 drives a shaft 70, which is journaled in bearing brackets 72 mounted onto frame 64. Shaft 70, in turn, drives a centrifugal impeller 76 that is housed in a scroll 78. Impeller 76 includes a plurality of vanes 80 rotating about shaft 70 to provide a negative pressure that draws air in through ventilation system 20. Scroll 78 defines an upwardly extending rectangular discharge port 82 at its upper end. Centrifugal fan assembly 46 can be a conventional Series 41 AFSQ centrifugal fan commercially available from Greenheck Fan Corporation, located in Schofield, Wis., and is capable of producing flow rates between 3000 CFM and 180000 CFM. It should be appreciated, however, that fan assembly 46 could include any alternative fan other that a centrifugal fan so long as the fan is suitable for exhausting air from the building as desired.

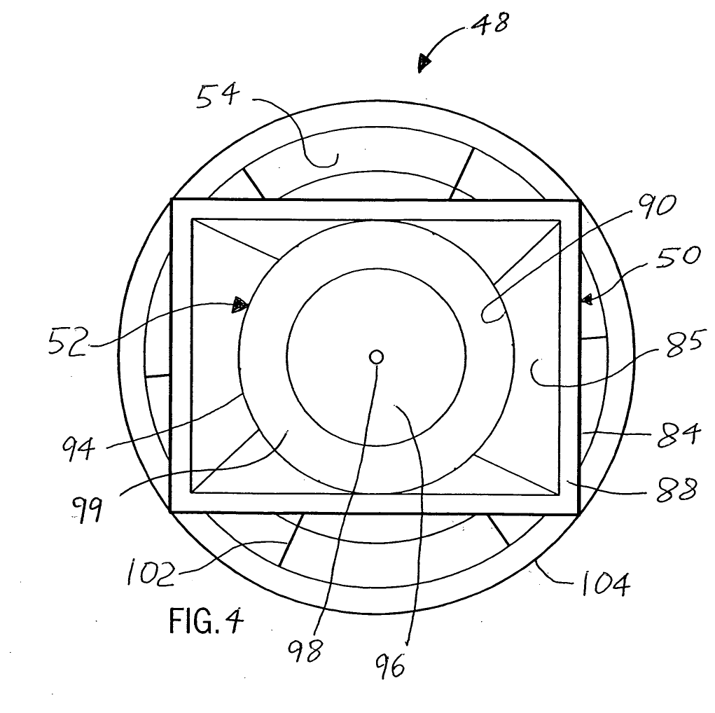

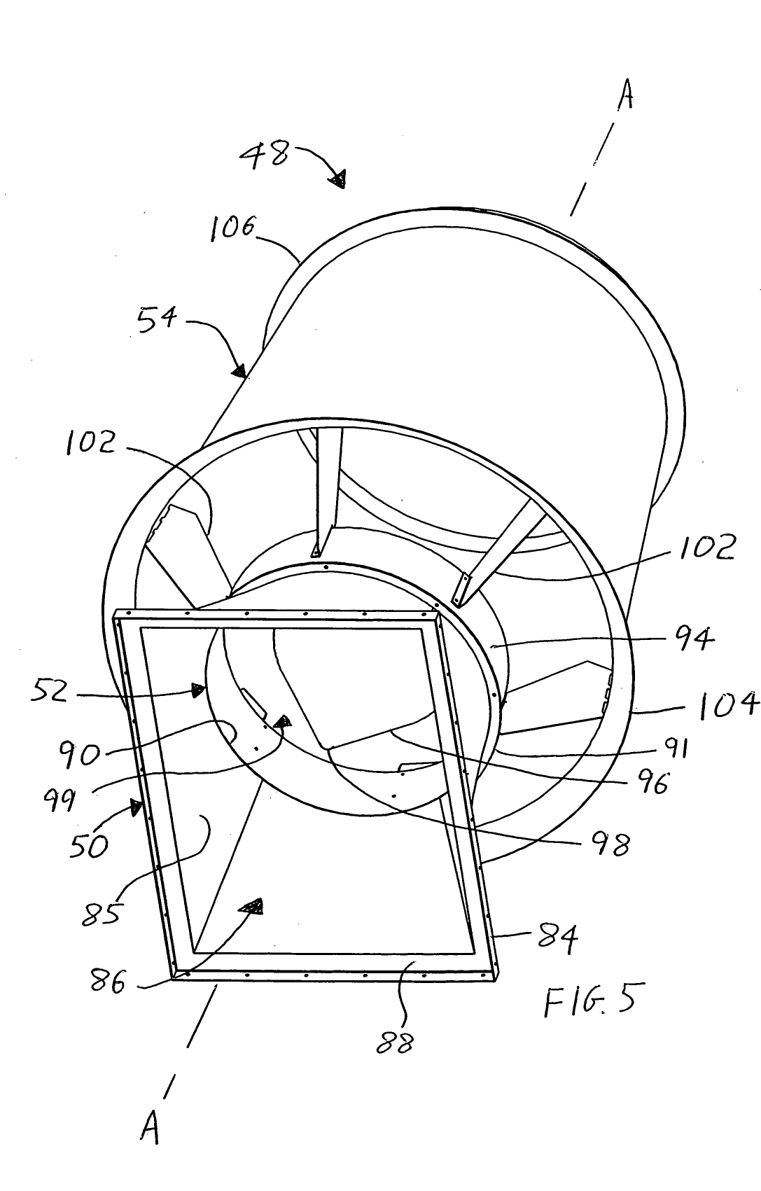

Referring to FIGS. 3-5, stack extension 50 increases the height of exhaust fan assembly 42 which, in turn, increases the plume height of expelled exhaust air. Stack extension 50 includes an enclosed wall 85 that converges radially inwardly in a direction downstream with respect to the flow of exhaust air. Wall 85 includes a rectangular base 88 connected to discharge port 82 via a mounting flange 84. A conduit 86 extends vertically through wall 85, and receives the exhaust exiting centrifugal fan assembly 46 along the direction of Arrows 100. Wall 85, which can be formed from sheet metal, transitions from its rectangular base 88 to a cylindrical upper end 90 which provides an outlet end of the extension 50. Stack extension 50 thus provides a rectangular-to-round transition that connects the fan housing 44 to modular air entraining assembly 51, as will now be described.

Modular air entraining assembly 51 includes nozzle 52 and windband 54. Nozzle 52 includes an outer wall in the form of a vertically extending cylindrical collar 94 and an inner wall 96 spaced radially inwardly from collar 94. Cylindrical collar 94 is fastened to extension 50 via a cylindrical mounting flange 95 bolted to an annular mounting flange 91 extending radially outwardly from the upper end 90 of extension. Inner wall 96 is centrally disposed in collar 94 such that collar 94 circumscribes inner wall 96. Inner wall 96 is a frustoconical member resembling the shape of an inverted cone with its tip 98 extending down into conduit 86, and terminating approximately vertically midway through extension 50. Accordingly, inner wall 96 diverges toward collar 94 to define an annular converging conduit 99 whose cross-sectional area decreases in a direction downstream with respect to exhaust flow. During operation, the exhaust air accelerates as it travels through annular conduit 99 and exits nozzle 52 along the direction indicated by Arrows 101.

Windband 54 is mounted at the top of exhaust stack 48 and around the nozzle 52. A set of gussets 102 is attached around the perimeter of the collar 94 and these extend upward and radially outward from its top rim and fasten to the windband 54. The windband 54 is essentially frustum-shaped with a large circular bottom opening coaxially aligned with the annular nozzle 52 about central axis A-A. The bottom end of the windband 54 is flared by an inlet bell 104 and the bottom rim of the inlet bell 104 is aligned substantially coplanar with the rim of the nozzle 52. The top end of the windband 54 is terminated by a circular cylindrical ring section 106 that defines the exhaust outlet of the exhaust fan assembly 42.

As best shown in FIG. 3, the windband 54 is dimensioned and positioned relative to the nozzle 52 to entrain a maximum amount of ambient air into the exhaust air exiting the nozzle 52. The ambient air enters through an annular gap providing an air entrainment path formed between the nozzle 52 and the inlet bell 104 as indicated by arrows 108. It mixes with the swirling, high velocity exhaust traveling through nozzle 52 along the direction of Arrows 107, and the mixture is expelled through the exhaust outlet at the top of the windband 54 along the direction of Arrows 109.

A number of features on this system serve to enhance the entrainment of ambient air and improve fan efficiency. The flared inlet bell 104 at the bottom of the windband 54 has been found to increase ambient air entrainment by several percent. This improvement in air entrainment is relatively insensitive to the angle of the flare and to the size of the inlet bell 104. The same is true of the ring section 110 at the top of the windband 54. In addition to any improvement the ring section 110 may provide by increasing the axial height of the windband 54, it has been found to substantially increase ambient air entrainment. Testing has shown that minor changes in its length do not significantly alter this performance enhancement.

It has been discovered that ambient air entrainment is maximized by minimizing the overlap between the rim of the nozzle 52 and the bottom rim of the windband 54. In the preferred embodiment these rims are aligned substantially coplanar with each other such that there is no overlap.

Furthermore, it has been discovered that the shape of nozzle 52 improves the operation of exhaust fan assembly 42 with respect to conventional systems. Specifically, it is common practice in this art to shape the nozzle such that the exhaust is directed radially inward to “focus” along the central axis A-A. This can be achieved by tapering the outer wall radially inward or by tapering both the inner and outer walls radially inward to direct the exhaust towards the central axis A-A. It is a discovery of the present invention that ambient air entrainment can be increased and pressure losses decreased by shaping the nozzle 52 such that exhaust air is directed radially outward rather than radially inward towards the central axis A-A. In the preferred embodiment this is achieved by providing inner wall 96 that diverges towards outer collar 94. Air entrainment is increased by several percent and pressure loss can also be significantly reduced with this structure. It is believed the increase in air entrainment is due to the larger nozzle perimeter that results from not tapering the collar 94 radially inward. It is believed that the reduced pressure loss is due to the fact that most of the upward exhaust flow through the annular conduit 99 is near the collar 94 and that by keeping this collar 94 straight, less exhaust air is diverted, or changed in direction by the nozzle 52.

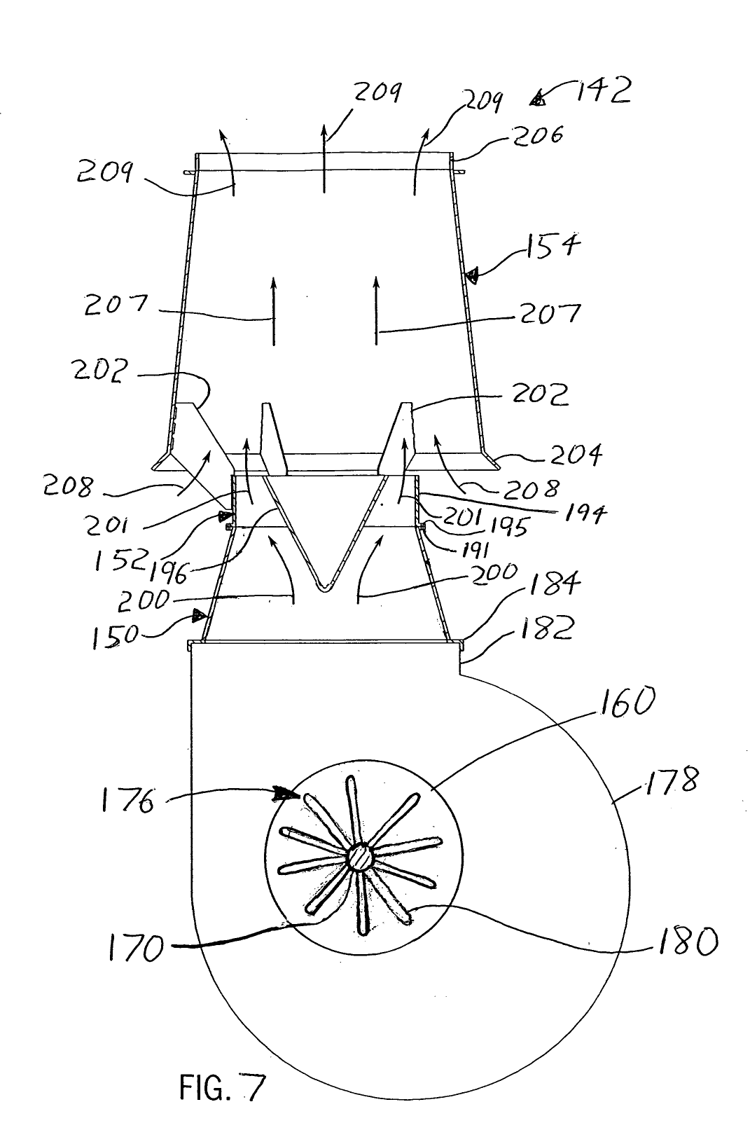

In addition to the performance enhancements discussed above, the structure of the exhaust fan assembly lends itself to customization to meet the specific needs of users. For instance, referring to FIG. 7, an exhaust fan assembly 142 constructed in accordance with an alternative embodiment is illustrated having reference numerals corresponding to like elements illustrated in FIG. 3 incremented by 100 for the purposes of clarity and convenience. Fan assembly 142 includes a fan housing 144 having a cylindrical outlet 182 that connects to a cylindrical stack extension 150 constructed having a cylindrical base and upper end for connection between fan housing outlet 182 and nozzle collar 194 in the manner described above.

Accordingly, one aspect of the present invention provides a extension that increases plume height while permitting air entraining assembly 51 to be mounted onto a fan regardless of the shape of the fan discharge opening. In this regard, it should be appreciated that stack extension 50 and 150 can transition from any shape at its base to a cylindrical shape to accommodate virtually any suitable fan housing. Alternatively, if the fan housing outlet is sufficiently high, air entraining assembly 51 and 151 could be mounted directly onto the fan housing.

It should further be appreciated that air entraining assembly 51 and 151 can be implemented in combination with a ventilation system 20 whose fan assembly is disposed on roof 40 as described above, or located in the building or otherwise at a location remote from the location at which the air entraining assembly is mounted onto rooftop 40. Air entraining assembly 51 and 151 could, for example, be connected to the riser 38, or suitable connector, either directly or indirectly via extension 50 and 150, which would increase the height of the exhaust fan assembly, and thus also increase the plume height of the expelled exhaust air to a desired level. In such an embodiment, the fan assembly 46 could be disposed anywhere in the building ventilation system 20 (for example in the manifold 34, in the individual conduits 32, or in the riser 38 at a location below or above roof 40). Advantageously, one aspect of the present invention provides flexibility when mounting a modular air entraining assembly onto a building.

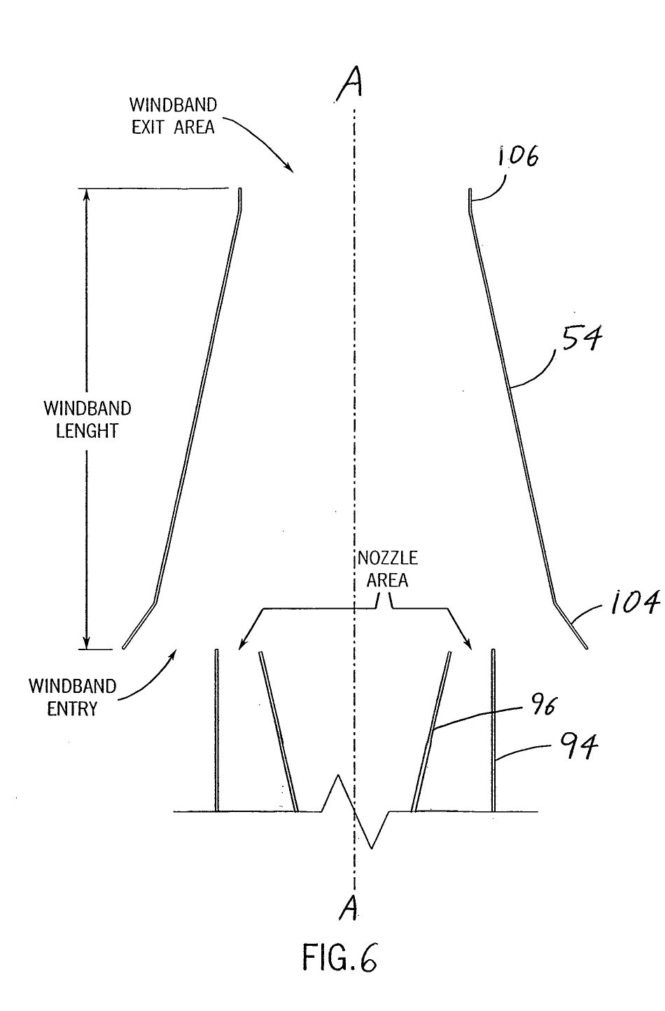

It is thus appreciated that user specifications accommodated by aspects of the present invention include volume of exhaust air, plume height, amount of dilution with ambient air, and assembly height above roof top 40. User objectives include minimizing cost, maximizing performance, and maximizing safety. Such customization is achieved by selecting the size, or horsepower, of the fan motor 68, and by changing the four system parameters illustrated in FIG. 6.

Nozzle Exit Area:

Increasing this parameter decreases required motor HP, decreases ambient air entrainment, decreases plume rise. Decreasing this parameter increases required motor HP, increases ambient air entrainment, increases plume rise.

Windband Exit Area:

Increasing this parameter increases ambient air entrainment, does not significantly affect plume rise or fan flow. Decreasing this parameter decreases ambient air entrainment, does not significantly affect plume rise or fan flow.

Windband Length:

Increasing this parameter increases ambient air entrainment, increases plume rise, does not affect fan flow. Decreasing this parameter decreases ambient air entrainment, decreases plume rise, does not affect fan flow.

Windband Entry Area (Minor Effect)

Increasing this parameter increases ambient air entrainment, increases plume rise, does not affect fan flow. Decreasing this parameter decreases ambient air entrainment, decreases plume rise, does not affect fan flow.

The above has been described as a preferred embodiment of the present invention. It will occur to those that practice the art that many modifications may be made without departing from the spirit and scope of the invention. In order to apprise the public of the various embodiments that may fall within the scope of the invention, the following claims are made.

1. An exhaust fan assembly for expelling exhaust air from a building, the exhaust fan assembly comprising:
a fan housing containing a fan that draws the exhaust air from the building and forces the air through a fan housing outlet;
a nozzle disposed downstream of the fan housing, the nozzle comprising an outer enclosed wall and an inner wall that form a converging annular conduit receiving the exhaust air from the fan; and
a windband disposed downstream of the nozzle, the windband providing an air entrainment path receiving ambient air such that the ambient air mixes with the exhaust air in the windband, the windband further comprising an outlet that expels the mixed air.

2. The exhaust fan assembly as recited in claim 1, in which the fan is a centrifugal fan.

3. The exhaust fan assembly as recited in claim 1, in which the inner wall is substantially centrally disposed with respect to the outer wall.

4. The exhaust fan assembly as recited in claim 3, in which the inner wall is frustoconical.

5. The exhaust fan assembly as recited in claim 1, in which the inner wall diverges toward the outer wall.

6. The exhaust fan assembly as recited in claim 1, further comprising a connector having a rectangular base connected to the fan housing and a cylindrical upper end connected to the outer enclosed wall of the nozzle.

7. The exhaust fan assembly as recited in claim 1, in which the windband is mounted to the upper end of the outer enclosed wall and receives the exhaust from the nozzle,

8. The exhaust fan assembly as recited in claim 1, in which the windband has a frustum-shape with a circular opening at its lower end which is substantially coaxial with said nozzle

9. The exhaust fan assembly as recited in claim 8, in which the lower end of the windband is substantially coplanar with said nozzle.

10. The exhaust fan assembly as recited in claim 1, in which the windband is flared at its lower end to form an inlet bell.

11. The exhaust fan assembly as recited in claim 1, in which a cylindrical ring is formed at the upper end of the windband.

12. An exhaust fan assembly for expelling exhaust air from a building, the exhaust fan assembly comprising:
a fan housing containing a fan that draws the exhaust air from the building and forces the air through a fan housing outlet;
a nozzle disposed downstream of the fan housing, the nozzle comprising an outer enclosed wall and an inner wall that diverges towards the outer wall to form a converging conduit receiving the exhaust air from the fan; and
a windband disposed downstream of the nozzle, the windband providing an air entrainment path receiving ambient air such that the ambient air mixes with the exhaust air in the windband, the windband further comprising an outlet that expels the mixed air.

13. The exhaust fan assembly as recited in claim 12, in which the fan is a centrifugal fan.

14. The exhaust fan assembly as recited in claim 12, in which the converging conduit is annular.

15. The exhaust fan assembly as recited in claim 12, in which the inner wall is substantially centrally disposed with respect to the outer wall.

16. The exhaust fan assembly as recited in claim 15, in which the inner wall is frustoconical.

17. The exhaust fan assembly as recited in claim 12, in which the inner wall diverges toward the outer wall.

18. The exhaust fan assembly as recited in claim 12, further comprising a connector having a rectangular base connected to the fan housing and a cylindrical upper end connected to the outer enclosed wall of the nozzle.

19. The exhaust fan assembly as recited in claim 12, in which the windband is mounted to the upper end of the outer enclosed wall and receives the exhaust from the nozzle,

20. The exhaust fan assembly as recited in claim 12, in which the windband has a frustum-shape with a circular opening at its lower end which is substantially coaxial with said nozzle

21. The exhaust fan assembly as recited in claim 20, in which the lower end of the windband is substantially coplanar with said nozzle.

22. The exhaust fan assembly as recited in claim 12, in which the windband is flared at its lower end to form an inlet bell.

23. The exhaust fan assembly as recited in claim 12, in which a cylindrical ring is formed at the upper end of the windband.

24. An exhaust fan assembly connected to a ventilation network of a building for expelling exhaust air from the building, the exhaust fan assembly comprising:
a duct connected to the ventilation network that receives the exhaust air at one end, the conduit defining an outlet end;
a fan housing defining an inlet that is connected to the outlet of the duct; the fan housing containing a centrifugal fan that draws the exhaust air from the building and forces the air through a fan housing outlet;
a connector having a rectangular base connected to the fan housing and a cylindrical upper end, the connector defining a conduit that receives receiving the exhaust air from the fan housing outlet;
a nozzle comprising 1) an outer enclosed wall connected to the cylindrical upper end of the connector and 2) an inner wall that diverges towards the outer enclosed wall to form a converging annular conduit receiving the exhaust air from the connector conduit; and
a windband connected to the outer enclosed wall of the nozzle, the windband having a frustum-shape with a circular opening at its lower end which is coaxial with said nozzle and the lower end is substantially coplanar with said nozzle.
